(19) United States
(12) Patent Application Publication
(10) Pub. No.: US 2005/0269299 A1
(43) Pub. Date: Dec. 8, 2005

(54) Method for welding a metal foil to a cylindrical metal pin

(75) Inventor: Roland Rittner, Herbrechtingen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/142,194

(22) Filed: Jun. 2, 2005

(30) Foreign Application Priority Data
Jun. 8, 2004 (DE) 102004027806.7

(51) Int. Cl. B32B 7/00

(52) U.S. Cl. 219/121.64

(57) ABSTRACT

The invention relates to a method for welding a metal foil to a metal pin, these components being intended for use as supply conductors in lamps, the metal foil being pressed onto the metal pin in order for the welding process to be carried out, and the region of the metal foil which adjoins the metal pin is heated and melted in punctiform fashion at a plurality of locations via a laser, so that after the molten material has cooled, the metal foil and the metal pin are joined to one another in the vicinity of these locations.

### I. TECHNICAL FIELD

The invention relates to a method for welding a metal foil to a cylindrical metal pin, which components are intended for use as supply conductors in lamps.

### II. BACKGROUND ART

Laid-Open specification EP 1 066 912 A1 describes the welding of a molybdenum foil to a cylindrical tungsten pin by means of a resistance weld. This method has the drawback that the welding electrodes have to be replaced at regular intervals, on account of becoming worn, which interrupts the production process.

### III. DISCLOSURE OF THE INVENTION

The object of the invention is to provide an improved method for welding a metal foil to a cylindrical metal pin which avoids the abovementioned drawbacks.

This object is achieved by a method for welding a metal foil to a metal pin, these components being intended for use as supply conductors in lamps, the metal foil being pressed onto the metal pin in order for the welding process to be carried out, wherein the region of the metal foil which adjoins the metal pin is heated and melted in punctiform fashion at a plurality of locations by means of a laser, so that after the molten material has cooled, the metal foil and the metal pin are joined to one another in the vicinity of these locations.

No welding electrodes are required when using the welding method according to the invention, unlike in the method according to the prior art. Accordingly, there is also no interruption to the production process as a result of worn welding electrodes having to be exchanged.

The method according to the invention is advantageously suitable for welding a thin metal foil with a thickness of less than or equal to 150 μm, such as for example a molybdenum foil, which is customarily used as a gastight current leadthrough in lamp vessels formed from quartz glass, to a metal pin, in particular a cylindrical lamp electrode made from tungsten or a supply conductor wire made from molybdenum or the end section of a tungsten incandescent filament.

To prevent the molten material from contracting and forming hump-like elevations on account of the surface tension, which would make it impossible to form an areal join to the metal pin, the laser is operated in pulsed mode, and the duration of the laser pulses is set to a value of less than or equal to 1.0 millisecond. The diameter of the laser beam is advantageously matched to the width or transverse dimension of the contact region of metal foil and metal pin, in order to ensure that the heat which is generated by the laser is transmitted to the material of the metal pin, so that it is impossible for any holes to form in the metal foil as a result of overheating. Therefore, a laser with a beam diameter of less than or equal to 0.5 millimeter is advantageously used to weld the metal pins which are customarily used in lamp engineering. Furthermore, it has proven advantageous for the metal pin to be flattened prior to the welding process and for the surface of the metal pin which has been formed by this flattening operation to be brought into contact with the metal foil. Flattening the metal pin increases the bearing surface area between the metal foil and the metal pin. Accordingly, the two metal parts can be joined to one another by a greater number of weld spots, and alignment of the laser is simplified. To ensure a sufficient contact pressure over the entire contact surface between metal foil and metal pin, avoiding any spaces between them, and also to make the entire contact surface accessible to the welding process, the contact pressure is advantageously generated by means of a continuous gas stream, which is directed onto the metal foil during the welding process, or by a suitable mechanical pressure-exerting device.

### IV. BRIEF DESCRIPTION OF THE DRAWINGS

The invention is explained in more detail below with reference to a preferred exemplary embodiment.

FIG. 1 diagrammatically depicts a molybdenum foil and a cylindrical molybdenum pin which have been joined to one another by four weld spots using the welding method according to the invention.

FIGS. 2 and 3 show lamps in which the welded join in accordance with the invention is employed.

### V. BEST MODE FOR CARRYING OUT THE INVENTION

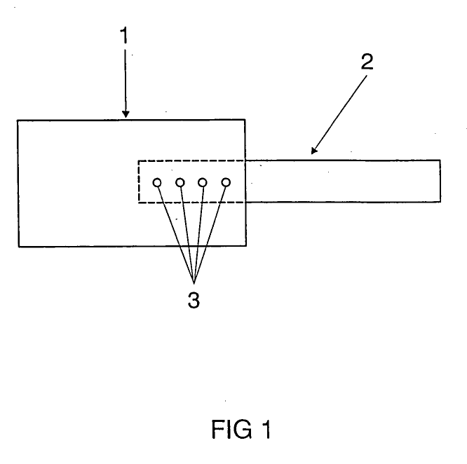

The molybdenum foil 1 illustrated in FIG. 1 is 27 μm thick. The molybdenum pin 2 is cylindrical in form and has a diameter of 0.78 mm. To be welded together, the molybdenum foil 1 and the molybdenum pin 2 are clamped in a holder, arranged such that they overlap and are in contact with one another. The four weld spots 3 are produced with the aid of a neodymium:yttrium aluminum garnet laser, which generates infrared radiation with a wavelength of 1064 nm. The laser is operated in pulsed mode with a mean power of 100 Watts and a peak pulse power of 8 kilowatts. The duration of the pulses is preferably 0.5 ms. The diameter of the laser beam is 0.1 mm. The four weld spots are arranged in a row, at intervals of 0.5 mm. To produce the four weld spots 3, the laser is directed onto the surface of the molybdenum foil 1 remote from the molybdenum pin 2, in each case onto a spot of the contact surface between molybdenum foil 1 and molybdenum pin 2, and at this spot the material of the molybdenum foil 1 is melted by means of the laser pulses. In the figure, the portion of the molybdenum pin 2 which overlaps the molybdenum foil 1 is indicated in dashed lines, since in the diagrammatic representation of the figure it would normally be covered by the molybdenum foil 1 and would consequently be invisible. In each case one laser pulse is sufficient to produce the weld spots. The pulse power of a laser pulse is, preferably 750 Watts. During the welding operation, the molybdenum foil 1 is pressed onto the molybdenum pin 2 with the aid of a movable gas nozzle, which bears against the molybdenum foil 1 and out of which an inert gas, for example nitrogen, flows continuously. However, good welding results are also achieved with laser pulses with a pulse duration of just 0.3 ms and a pulse power of just 500 Watts.

The invention is not restricted to the exemplary embodiment which has been explained in more detail above. By way of example, the molybdenum pin 2 may be flattened in the contact region, in order to increase the size of the contact surface with the molybdenum foil 1. Moreover, the welding method can also be applied to foils and cylindrical pins of different thicknesses and made from other metals. In particular, the method according to the invention is suitable for welding molybdenum foils to cylindrical pins made from molybdenum or tungsten and also for welding tantalum foils to cylindrical pins formed from molybdenum or tungsten. The metal pins do not necessarily have to be cylindrical, but rather could also be polygonal, for example rectangular or square, in cross section. It is also possible for any other suitable type of laser to be used for the welding instead of the type of laser mentioned above.

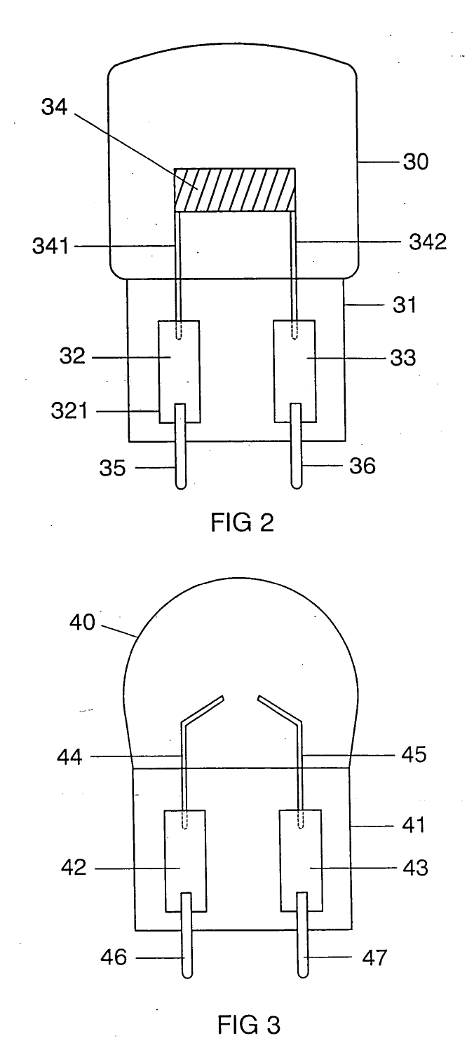

The incandescent lamp illustrated in FIG. 2 has a lamp vessel 30 made from quartz glass with a sealed end 31 which has two molybdenum foils 32, 33 embedded in the sealed end 31. An incandescent filament 34, the filament ends 341, 342 of which are in each case joined to one of the molybdenum foils 32 and 33 by a plurality of laser weld spots in a similar manner to that which has been diagrammatically depicted in FIG. 1, is arranged inside the lamp vessel 30. That end 321 of the molybdenum foils 32, 33 which is remote from the interior of the lamp vessel 30 has in each case been joined to a supply conductor wire 35 and 36, respectively, made from molybdenum, which leads out from the sealed end 31 of the lamp vessel 30, by means of four laser weld spots, as diagrammatically depicted in FIG. 1.

The discharge lamp illustrated in FIG. 3 has a lamp vessel 40 made from quartz glass with a sealed end 41 which has two molybdenum foils 42, 43 embedded in the sealed end 41. Two electrodes 44, which are in each case joined to one of the molybdenum foils 42 and 43 by a plurality of laser weld spots, in a similar way to what has been diagrammatically depicted in FIG. 1, are arranged inside the lamp vessel 40. That end of the molybdenum foils 42, 43 which is remote from the interior of the lamp vessel 40 has in each case been joined to a supply conductor wire 46 or 47, respectively, made from molybdenum, which leads out of the sealed end 41 of the lamp vessel 40, by four laser weld spots, as diagrammatically depicted in FIG. 1.

1. A method for welding a metal foil to a metal pin, these components being intended for use as supply conductors in lamps, the metal foil being pressed onto the metal pin in order for the welding process to be carried out, wherein the region of the metal foil which adjoins the metal pin is heated and melted in punctiform fashion at a plurality of locations by means of a laser, so that after the molten material has cooled, the metal foil and the metal pin are joined to one another in the vicinity of these locations.

2. The method as claimed in claim 1, wherein the laser has a beam diameter of less than or equal to 0.5 mm.

3. The method as claimed in claim 1, wherein the laser is operated in pulsed mode and the pulse duration of a laser pulse is less than or-equal to 1.0 millisecond.

4. The method as claimed in claim 1, wherein the thickness of the metal foil is less than or equal to 150 μm.

5. The method as claimed in claim 1, wherein the metal pin is flattened, and the flattened surface of the metal pin is brought into contact with the metal foil in order for the welding process to be carried out.

6. The method as claimed in claim 1, wherein the metal foil is a molybdenum foil, and the metal pin is a molybdenum pin or a tungsten pin.

7. The method as claimed in claim 1, wherein the metal pin is designed as part of a supply conductor wire, of an incandescent filament or of a gas discharge electrode.

8. A lamp with current leadthroughs passing through a closed lamp vessel, these leadthroughs having at least one metal foil and a metal pin joined to it, wherein said metal foil and said metal pin are joined to one another by a plurality of laser-welded spots.

9. The lamp as claimed in claim 8, wherein said metal foil is in the form of a molybdenum foil, and said metal pin is in the form of a tungsten pin or a molybdenum pin.

10. The lamp as claimed in claim 8, wherein said metal pin is designed as part of a supply conductor wire or of a gas discharge electrode or as the end of an incandescent filament.

11. The method as claimed in claim 6, wherein the metal pin is designed as part of a supply conductor wire, of an incandescent filament or of a gas discharge electrode.

12. The lamp as claimed in claim 9, wherein said metal pin is designed as part of a supply conductor wire or of a gas discharge electrode or as the end of an incandescent filament.
